(19) United States
(12) Patent Application Publication
(10) Pub. No.: US 2016/0191512 A1
(43) Pub. Date: Jun. 30, 2016

(54) PREDICTIVE USER AUTHENTICATION

(71) Applicant: McAfee, Inc., Santa Clara, CA (US)

(72) Inventors: Igor Tatourian, Santa Clara, CA (US); Norman Yee, Folsom, CA (US); Sudip Chahal, Gold River, CA (US); Greeshma Yellareddy, San Francisco, CA (US); David Levant, Lehavim (IL); Tobias M. Kohlenberg, Portland, OR (US); Hong Li, El Dorado Hills, CA (US); Rita H. Wouhaybi, Portland, OR (US)

(73) Assignee: McAfee, Inc., Santa Clara, CA (US)

(21) Appl. No.: 14/583,646

(22) Filed: Dec. 27, 2014

(51) Int. Cl. H04L 29/06

(52) U.S. Cl. CPC H04L 63/0861

(57) ABSTRACT

In an example, a system and method for predictive user authentication is disclosed. The system may include proximity sensors, computer vision systems, and other provisions for monitoring users' movements throughout a facility. A predictive security engine may also be programmed with heuristic data to recognize such factors as a user's face, gait, or average appearance. When a user approaches a terminal, the system may preemptively compute a confidence score regarding the user's authenticity. Based on the confidence score, the system will determine how much additional authentication is necessary. The system may also provide context-sensitive data to the user based on location or activities. Thus, authentication to the system is made easier to the user, and the user receives more relevant data for his or her activities.

### FIELD OF THE DISCLOSURE

This application relates to the field of computer security, and more particularly to a system and method for predictive user authentication.

### BACKGROUND

Authentication is a key concept to computer security. Authentication is a process by which a first endpoint—meaning a user, device, or other logical terminal—satisfies a second endpoint that the first endpoint is who (or what) he (she or it) says they are. Because it is logically impossible to authenticate the first endpoint with 100% confidence, each second endpoint must determine, consciously or unconsciously, the degree of confidence that is acceptable in a particular context.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 is a block diagram of a security-enabled network according to one or more examples of the present Specification.

FIG. 2 is a block diagram of a computing device according to one or more examples of the present Specification.

FIG. 3 is a block diagram of a server according to one or more examples of the present Specification.

FIG. 4 is a functional block diagram of a predictive authentication system according to one or more examples of the present Specification.

FIG. 5 is a functional block diagram of a trust score engine according to one or more examples of the present Specification.

FIG. 6 is a flow chart of a method according to one or more examples of the present Specification.

FIG. 7 is a flow chart of a method according to one or more examples of the present Specification.

### DETAILED DESCRIPTION OF THE EMBODIMENTS

### Overview

In an example, a system and method for predictive user authentication is disclosed. The system may include proximity sensors, computer vision systems, and other provisions for monitoring users' movements throughout a facility. A predictive security engine may also be programmed with heuristic data to recognize such factors as a user's face, gait, or average appearance. When a user approaches a terminal, the system may preemptively compute a confidence score regarding the user's authenticity. Based on the confidence score, the system will determine how much additional authentication is necessary. The system may also provide context-sensitive data to the user based on location or activities. Thus, authentication to the system is made easier to the user, and the user receives more relevant data for his or her activities.

### EXAMPLE EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments many have different advantages, and no particular advantage is necessarily required of any embodiment.

In some cases, the degree of confidence of authentication is in direct opposition to ease of use. Passwords are but one illustrative example of an authentication mechanism. A password is a string of characters that should theoretically be known only to the authorized user. However, in decades of practice, passwords have been found to be inherently difficult to do right. In the early days of computing, a typical password might have been a single short dictionary word typed all in lowercase letters. To make the password easy to remember, a user may have chosen something familiar, such as her mother's maiden name or the name of a favorite pet. The user may then have kept the same password for years on end.

While such simple passwords were convenient and easy for users, they were found to possess some inherent flaws. A short password constructed of only 26 possible lowercase characters possesses low entropy. Thus, as computers became faster, it became trivial for modern computers to “brute force” such passwords by guessing every single combination. Furthermore, the search space could be reduced with so-called “dictionary attacks.” In a dictionary attack, an attacker uses a dictionary of thousands or millions of English words to search for matches, which further reduces the search space. Finally, the use of personally-relevant data, such as a mother's maiden name or the name of a favorite pet, made passwords even easier for attackers to guess.

As enterprise IT departments began to recognize the flaws in weak passwords, password requirements began to evolve to meet the threat. This saw the advent of increasingly complex password schemes, in which, for example, a password may be required to be no fewer than 8 characters, and include a mixture of at least one each of uppercase letters, lowercase letters, numbers, and special symbols, and may not be based on a dictionary word. To further increase security, an enterprise might require users to rotate their passwords, for example every 90 days, without reusing any previous passwords.

While such complex passwords are theoretically more secure then short all-lowercase dictionary passwords, they present their own difficulties. Because such complicated passwords lack relevant context, they're much more difficult for users to remember. To keep track of difficult, ever-changing passwords, many users resorted to simply writing them down. In that case, an attacker who has physical access to a user's location need not go through the traps of trying to guess the password. He simply had to find the Post-It note that the user had hidden under his keyboard or in a desk drawer with his password on it.

To address some of the inherent limitations of passwords, many enterprises began requiring multifactor authentication. In multifactor, authentication is provided not only by something that the user knows (i.e., a password), but also based on something that the user possesses, or is. For example, a user may be required to provide a physical RFID token embedded in an ID badge in addition to a password. Thus, the two factors in this case are something that the user should exclusively know (the password), and something that the user should exclusively possess (the RFID tag). In other cases, biometric authentication may be used, such as fingerprints or retinal scans, representing something that the user is (e.g., somebody with a matching fingerprint). In yet another example, an out-of-band factor may be used for authentication. For example, a user may be required to input a password, and may also receive a text message on his or her cell phone with a one-time authorization code.

In another example, a user is provided in advance with a number of one-time authorization codes. Whenever the user attempts authenticate from a new machine or a new location, he may be required to provide one of the one time authorization codes.

While multifactor authentication may be more secure then single factor authentication, it is also more complicated. Thus, it is inconvenient for users to access enterprise resources, particularly in an environment where a user does not sit still at a single desk all day, if he or she must constantly authenticate with two or more factors.

Consider as one nonlimiting example a hospital. In the case of a hospital, the user may be a doctor or nurse who must go from room to room treating many different patients and interacting with the network many different locations. These locations may include kiosks or terminals, where a user should be able to log in and see relevant information, preferably in relevant context. For example, when a doctor is treating a patient in a hospital room, she may wish to login to a nearby computer and be able to see and update relevant healthcare information about the user, including accessing his chart and prescribing medications. When she is in her office, it may be more beneficial for her to access her e-mail.

As described above, the goals of confidence and ease of use appear to be in direct conflict. A strong authentication scheme may require the doctor to swipe her badge, with an embedded RFID tag, at each terminal, and also enter a strong, complicated password. While this provides high confidence for authentication, the computer may in fact become a hindrance to the doctor's efficiency, rather than an asset.

To increase ease-of-use, the security scheme may be changed so that the doctor needs only swipe her RFID badge at each terminal. In this case, the system is much more convenient for the doctor, but if her RFID badge is stolen, the thief gains unfettered access to computing resources, including confidential patient information, and potentially to controlled substances.

Similar difficulties are encountered if the doctor carries a notebook computer, smart phone, or tablet with her. For increased security, it is beneficial to provide a short “lockout” period (around two minutes, for example), and require the doctor to enter a strong password or provide two-factor authentication any time she wishes to access the device. Greater ease of use would dictate an “always on” policy, or a long lockout period, but again, if the user loses the device, whoever finds it may have unfettered access.

Recognizing the inherent tension between ease-of-use and confidence in authentication, the current Specification provides a system and method for predictive user authentication in a networked system. In parts of this Specification, a hospital or doctor's office, with doctors and nurses interacting with kiosks or other terminals, may be used by way of nonlimiting illustration. It should be noted, however, that the teachings of this Specification are equally applicable to any context in which a balance between ease-of-use and confidence is desired.

While the teachings of this Specification are especially relevant to contexts in which a user may frequently move from place to place throughout the day, its teachings are not so limited. The teachings of this Specification could just as easily be applied to an office setting where a user enters a building, sits down at a single computer, and works at that computer throughout the day. In that case, the teachings of this Specification may enhance security by also recognizing when the user is away from his or her desk, thus locking out access so that bad actors cannot compromise the machine while the user is away.

According to the present Specification, a plurality of inputs may be used in combination with heuristics to predict with suitable confidence that a user is authentic before he or she attempts to authenticate to the system. This may include, for example, cameras in the parking lot that recognize the make, model, and or license plate number of a car that the user usually drives. Additional cameras may observe the user entering the building, and may match multiple factors, such as facial structure, gait, and even clothing to further contribute to a user's confidence score. As the user moves throughout the building, proximity triggers, such as RFID readers, may detect the presence of an RFID badge, or other physical authentication token, top detect ingress into or egress from certain areas.

Confidence in the user's authenticity may increase as the user's actions throughout the day are more or less consistent with the user's habits and/or routines. Thus, when the user finally presents himself or herself to a machine for authentication, a predictive authentication score has already been calculated. Based on the authentication score, the system may or may not require additional authentication. For example, with a high confidence score, the user may need to only swipe his or her RFID badge to gain access to the system. If the user has received a lower confidence score, he or she may need to enter a strong password as well. In some cases, a mismatch between the user's purported identity and the predictive authentication score may be so marked that the attempt to authenticate is flagged, and the user may need to physically verify himself or herself to enterprise security personnel before accessing the system.

Advantageously, as the user adapts his or her appearances or routine, the system may employ machine learning to adapt with them. For example, Dr. Jones may be a physician at a hospital that has a predictive authentication system in place. Based on Dr. Jones' previous habits, the predictive authentication system knows that she has a particular facial structure, has shoulder-length dark hair, and favors wearing scrubs and tennis shoes to work. Over a course of days, weeks, and months, each time that Dr. Jones shows up at the hospital with shoulder length dark hair, wearing scrubs, walking with her characteristic gait, and performing according to her regular routine, the predictive authentication profile for Dr. Jones is strengthened.

Dr. Jones' normal routine may include entering the hospital at 7:30 AM. At 7:35, she boots her computer and checks her email. From 7:35 to 9:00, she checks the news and weather, responds to email, and handles administrative tasks. From 9:00 to 11:30, she completes morning rounds with her patients. From 11:30 to 12:00, she eats lunch. From 12:00 to 1:00, she performs additional office work. And from 1:00 to 6:00 she performs surgeries and other procedures.

At each stage of Dr. Jones' progress throughout the day, she may need to log into various terminals to work within the system, such as prescribing medication, checking patients' charts, updating patients' charts, instructing nurses, and otherwise managing her practice. So long as Dr. Jones' appearance and activities remain consistent with her predictive authentication profile, she may be granted access to system resources, either with the no additional authentication, or with simple authentication such as swiping her access card. Thus, when Dr. Jones approaches a terminal, she may be authenticated before she steps up to the keyboard, or immediately after the RFID tag on her badge is read. Further advantageously, the system may anticipate, based on her location and activities, what she is doing and thus provide context-sensitive information and/or access to resources. For example, if she has just come from visiting Mr. Thompson in room 427, then when she approaches a terminal, she may be immediately authenticated, and presented with Mr. Thompson's chart.

If Dr. Jones varies from her routine, she is not necessarily denied authentication. For example, if Dr. Jones has an important business meeting one day, she may come to the hospital wearing a skirt suit and heels instead of scrubs and tennis shoes. This may alter both her appearance and her gait. Because of the important meeting, she may not go to her office at her normal time or follow her normal routine. In another example, she may cut her hair, or grow it longer. In yet another example, she may have an injury such as a sprained ankle that temporarily affects her gait.

Each of these events may reduce the predictive authentication score for Dr. Jones when she first approaches a terminal. If enough variations are present that Dr. Jones' predictive authentication score falls beneath a confidence threshold, additional verification may be required, such as requiring Dr. Jones to enter a strong password. When Dr. Jones successfully enters the strong password, her predictive authentication score increases.

It should be noted that telemetry is not limited to cameras and a computer vision system. Telemetry may also include, in appropriate circumstances, proximity triggers (such as triggers to detect ingress into or egress from an area), location sensors tied to a wearable device or implanted trigger such as an implanted RFID chip, and biometric authentication such as fingerprint, voice print, and retinal scans, all by way of nonlimiting example.

In some cases, Dr. Jones may be required by enterprise security policy to enter the strong password at least once a day, or once every several hours, to further improve security. This also helps to avoid a situation where Dr. Jones uses her password so infrequently that she forgets it. It will be evident that many other possible combinations of authentication requirements and thresholds may be provided.

Advantageously, the use of sensors and heuristics can both increase convenience, and simultaneously increase confidence. Thus, some of the tension between confidence and ease-of-use may be broken. Furthermore, heuristics are self-updating over time. For example, if Dr. Jones assumes more administrative responsibility at the hospital, so that she begins to wear scrubs and tennis shoes on certain days, and a suit and heels on other days, her continued successful authentication will result in her profile being updated. Over time, as a “new normal” evolves, Dr. Jones' profile evolves with it.

In certain embodiments, the system may also be adapted for predictive scaled authentication. In scaled authentication, the level of confidence required may be proportional to the sensitivity of the task. To provide just one nonlimiting example, prescribing a narcotic painkiller or other controlled substance, or accessing a pharmaceutical cabinet where controlled substances are kept, may require a higher confidence than prescribing an antibiotic, or simply scheduling a follow-up visit. Thus, if Dr. Jones wishes to refill Mr. Thompson's narcotic painkiller, she may need to provide a stronger authentication.

Advantageously, a predictive authentication system of the present Specification may predict that Dr. Jones is about to take an action that requires an increased authentication. For example, internal data and telemetry may inform the predictive authentication system that Mr. Thompson is nearly due for a refill to his prescription narcotic painkiller. Thus, when Dr. Jones approaches a terminal near Mr. Thompson's room, the system may predict that she is likely to refill Mr. Thompson's prescription. Rather than authenticate her, and then re-authenticate her when she attempts to fill the prescription, the predictive authentication system may determine an appropriate level of authentication for refilling the narcotic painkiller, and require that level of authentication up front.

In certain embodiments, a second authentication token (for example, in addition to an RFID badge) may be required at regular intervals, such as every four hours. In other cases, the timeout for the interval may be reset by the occurrence of a two-factor authentication even. For example, if it has been three hours since Dr. Jones last authenticated with a password, and she is required to authenticate with a password to refill a narcotic painkiller, the four-hour clock may be reset so that she does not need to provide manual authentication for another four hours thereafter.

Embodiments of the present Specification may also account for the fact that user behavior is likely to change under stressful or crisis situations. In such situations, it may be even more important to not hinder the user from performing her job function. For example, if Mr. Thompson suffers cardiac arrest and a “code blue” is announced, Dr. Jones may need to quickly and effectively respond to the situation. In responding to the crisis, Dr. Jones may need immediate access to Mr. Thompson's chart so that she can ensure that she is avoiding medicinal interactions, and so that she can gain access to any other information she may need to provide lifesaving treatment.

During the crisis, normal predictive authentication factors may become unreliable. For example, Dr. Jones' voice, verbiage, gait, motions, and activities may all immediately change in response to the crisis. A predictive authentication system lacking the intelligence to understand the crisis may then become a hindrance to Dr. Jones' lifesaving work rather than an aid, for example demanding a strong password or locking her out of the system precisely when she can least afford either.

However, this can be avoided by providing appropriate intelligence to account for emergency situations. In one example, by monitoring network traffic, the predictive user authentication system knows that a code blue has been raised for Mr. Thompson. Recognizing that doctors and nurses will be entering a crisis mode, the predictive user authentication system may make appropriate adjustments, including providing immediate access to relevant information or even providing directions to the nearest “crash cart.” In one example, after detecting the code blue condition, the predictive user authentication system retrieves Mr. Thompson's chart, and is ready to display it on a terminal in or near Mr. Thompson's room, with appropriate highlighting for potentially dangerous drug interactions.

Thus, when Dr. Jones and her team respond, they can immediately see where the nearest available crash cart is (the system may even use visible lights to direct the way, or to mark the room where it can be found), and with minimal authentication, gain access to Mr. Jones' chart. Immediately after swiping her RFID badge (or simply approaching near enough to the terminal), Dr. Jones may be presented with Mr. Thompson's chart, including highlighting of appropriate drug interactions that may be particularly relevant to lifesaving procedures (in lieu of a normal menu of many options that she may need to navigate). Dr. Jones thus has the most relevant information that she may need to perform her job and save Mr. Thompson's life.

This crisis mode may also account for the fact that Dr. Jones may not have her normal authentication means. For example, if she has laid her badge aside while eating lunch at her desk, when she rushes to the operating room to work on Mr. Thompson, she may not remember to stop and pick it up. Once again, this could be the worst possible times require her to enter a password for authentication. Thus, depending on the context, accumulated confidence from earlier in the day may be used to grant sufficient confidence that Dr. Jones is authentic, and to grant her access to the resources that she needs. In some cases, separate heuristics may even be kept to characterize Dr. Jones' performance under crisis, so that when the crisis occurs, “crisis heuristics” are used instead of normal heuristics.

In this example, access need not include only computing resources. For example, certain dangerous narcotics may be locked in storage drawers or closets, which can only be unlocked after appropriate authentication. In a moment of crisis, it may be necessary to provide quick access to those resources, in which case the predictive user authentication system may track Dr. Jones through the hospital, determined that she has entered the room, and immediately unlock her access to supplies that she may need. Once the crisis is ended, the predictive authentication system may relock those resources and resume normal operation.

It should also be noted that detection of a crisis mode is not limited to network alerts that are raised explicitly for the system to see. Rather, because the predictive user authentication system may include such resources as computer vision and other telemetry, the system may detect an increase of activity centered around Mr. Thompson's room, and by observing the changes in behavior, speed of motion, and indicators of urgency for a number of individuals, infer that a crisis is developing around Mr. Thompson. Thus, the system may prepare appropriate resources for responding to the crisis. Resumption of normal operation may then occur when human users are observed to be slowing down and winding down from the crisis activities. In certain examples, recordings of previous crisis situations may be used to train the system to recognize future crisis situations.

A system and method of execution profiling detection will now be described with more particular reference to the appended FIGURES. Throughout the FIGURES, common numerals are used to specify common elements across multiple FIGURES. However, this is not intended to imply a necessary or strict relationship between different embodiments disclosed herein. In some cases, one or more different examples or species of the same elements may be referred to in a hyphenated form. Thus, for example, the numerals 1xx-1 and 1xx-2 may refer to two different species or examples of a class of objects referred to as 1xx.

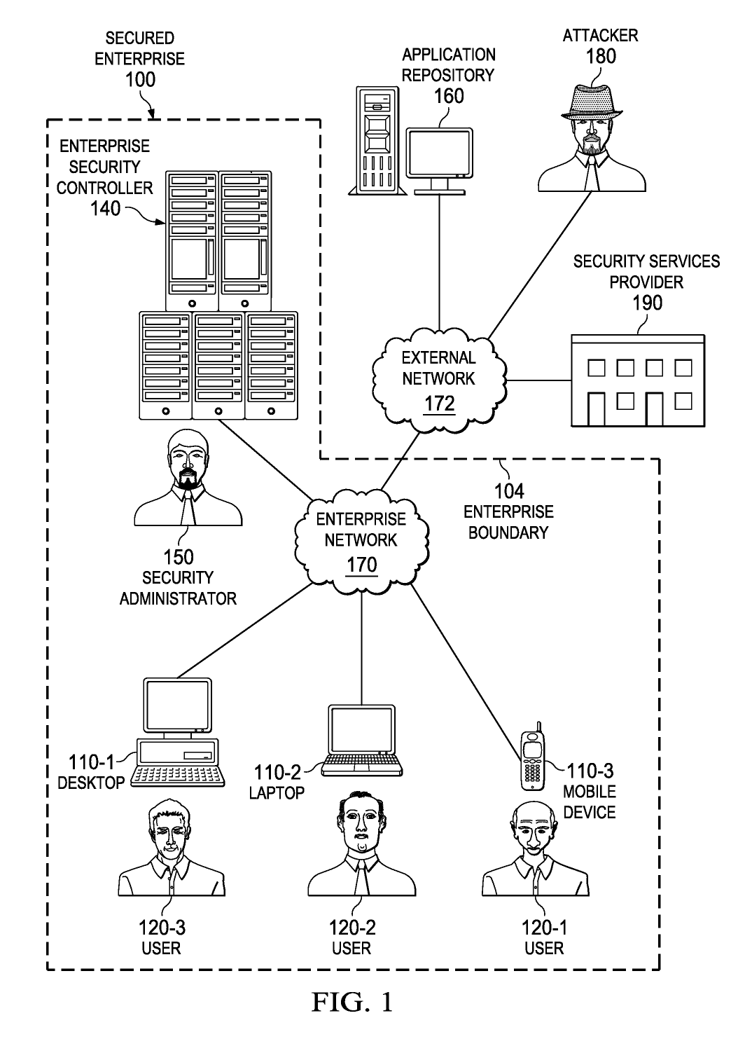

FIG. 1 is a network-level diagram of a secured enterprise 100 according to one or more examples of the present Specification. In the example of FIG. 1, a plurality of users 120 operate a plurality of client devices 110. Specifically, user 120-1 operates desktop computer 110-1. User 120-2 operates laptop computer 110-2. And user 120-3 operates mobile device 110-3.

Each computing device may include an appropriate operating system, such as Microsoft Windows, Linux, Android, Mac OSX, Apple iOS, Unix, or similar. Some of the foregoing may be more often used on one type of device than another. For example, desktop computer 110-1, which in one embodiment may be an engineering workstation, may be more likely to use one of Microsoft Windows, Linux, Unix, or Mac OSX. Laptop computer 110-2, which is usually a portable off-the-shelf device with fewer customization options, may be more likely to run Microsoft Windows or Mac OSX. Mobile device 110-3 may be more likely to run Android or iOS. However, these examples are not intended to be limiting.

Client devices 110 may be communicatively coupled to one another and to other network resources via enterprise network 170. Enterprise network 170 may be any suitable network or combination of one or more networks operating on one or more suitable networking protocols, including for example, a local area network, an intranet, a virtual network, a wide area network, a wireless network, a cellular network, or the Internet (optionally accessed via a proxy, virtual machine, or other similar security mechanism) by way of nonlimiting example. Enterprise network 170 may also include one or more servers, firewalls, routers, switches, security appliances, antivirus servers, or other useful network devices. In this illustration, enterprise network 170 is shown as a single network for simplicity, but in some embodiments, enterprise network 170 may include a large number of networks, such as one or more enterprise intranets connected to the internet. Enterprise network 170 may also provide access to an external network, such as the Internet, via external network 172. External network 172 may similarly be any suitable type of network.

One or more computing devices configured as an enterprise security controller (ESC) 140 may also operate on enterprise network 170. ESC 140 may provide a user interface for an awesome security administrator 150 to define enterprise security policies, which ESC 140 may enforce on enterprise network 170 and across client devices 120.

Secured enterprise 100 may encounter a variety of “security objects” on the network. A security object may be any object that operates on or interacts with enterprise network 170 and that has actual or potential security implications. In one example, object may be broadly divided into hardware objects, including any physical device that communicates with or operates via the network, and software objects. Software objects may be further subdivided as “executable objects” and “static objects.” Executable objects include any object that can actively execute code or operate autonomously, such as applications, drivers, programs, executables, libraries, processes, runtimes, scripts, macros, binaries, interpreters, interpreted language files, configuration files with inline code, embedded code, and firmware instructions by way of non-limiting example. A static object may be broadly designated as any object that is not an executable object or that cannot execute, such as documents, pictures, music files, text files, configuration files without inline code, videos, and drawings by way of non-limiting example. In some cases, hybrid software objects may also be provided, such as for example a word processing document with built-in macros or an animation with inline code. For security purposes, these may be considered as a separate class of software object, or may simply be treated as executable objects.

Enterprise security policies may include authentication policies, network usage policies, network resource quotas, antivirus policies, and restrictions on executable objects on client devices 110 by way of non-limiting example. Various network servers may provide substantive services such as routing, networking, enterprise data services, and enterprise applications.

Secure enterprise 100 may communicate across enterprise boundary 104 with external network 172. Enterprise boundary 104 may represent a physical, logical, or other boundary. External network 172 may include, for example, websites, servers, network protocols, and other network-based services. In one example, an application repository 160 is available via external network 172, and an attacker 180 (or other similar malicious or negligent actor) also connects to external network 172.

It may be a goal of users 120 and secure enterprise 100 to successfully operate client devices 110 without interference from attacker 180 or from unwanted security objects. In one example, attacker 180 is a malware author whose goal or purpose is to cause malicious harm or mischief. The malicious harm or mischief may take the form of installing root kits or other malware on client devices 110 to tamper with the system, installing spyware or adware to collect personal and commercial data, defacing websites, operating a botnet such as a spam server, or simply to annoy and harass users 120. Thus, one aim of attacker 180 may be to install his malware on one or more client devices 110. As used throughout this Specification, malicious software (“malware”) includes any security object configured to provide unwanted results or do unwanted work. In many cases, malware objects will be executable objects, including by way of non-limiting examples, viruses, trojans, zombies, rootkits, backdoors, worms, spyware, adware, ransomware, dialers, payloads, malicious browser helper objects, tracking cookies, loggers, or similar objects designed to take a potentially-unwanted action, including by way of non-limiting example data destruction, covert data collection, browser hijacking, network proxy or redirection, covert tracking, data logging, keylogging, excessive or deliberate barriers to removal, contact harvesting, and unauthorized self-propagation.

Attacker 180 may also want to commit industrial or other espionage against secured enterprise 100, such as stealing classified or proprietary data, stealing identities, or gaining unauthorized access to enterprise resources. Thus, attacker 180's strategy may also include trying to gain physical access to one or more client devices 110 and operating them without authorization, so that an effective security policy may also include provisions for preventing such access.

In another example, a software developer may not explicitly have malicious intent, but may develop software that poses a security risk. For example, a well-known and often-exploited security flaw is the so-called buffer overrun, in which a malicious user is able to enter an overlong string into an input form and thus gain the ability to execute arbitrary instructions or operate with elevated privileges on a computing device 200. Buffer overruns may be the result, for example, of poor input validation or use of insecure libraries, and in many cases arise in nonobvious contexts. Thus, although not malicious himself, a developer contributing software to application repository 160 may inadvertently provide attack vectors for attacker 180. Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new

Application repository 160 may represent a Windows or Apple “app store” or update service, a Unix-like repository or ports collection, or other network service providing users 120 the ability to interactively or automatically download and install applications on client devices 110. If application repository 160 has security measures in place that make it difficult for attacker 180 to distribute overtly malicious software, attacker 180 may instead stealthily insert vulnerabilities into apparently-beneficial applications.

In some cases, secured enterprise 100 may provide policy directives that restrict the types of applications that can be installed from application repository 160. Thus, application repository 160 may include software that is not negligently developed and is not malware, but that is nevertheless against policy. For example, some enterprises restrict installation of entertainment software like media players and games. Thus, even a secure media player or game may be unsuitable for an enterprise computer. Security administrator 150 may be responsible for distributing a computing policy consistent with such restrictions and enforcing it on client devices 120.

Secured enterprise 100 may also contract with or subscribe to a security services provider 190, which may provide security services, updates, antivirus definitions, patches, products, and services. McAfee®, Inc. is a non-limiting example of such a security services provider that offers comprehensive security and antivirus solutions. In some cases, security services provider 190 may include a threat intelligence capability such as the global threat intelligence (GTI™) database provided by McAfee Inc. Security services provider 190 may update its threat intelligence database by analyzing new candidate malicious objects as they appear on client networks and characterizing them as malicious or benign.

In another example, secured enterprise 100 may simply be a family, with parents assuming the role of security administrator 150. The parents may wish to protect their children from undesirable content, such as pornography, adware, spyware, age-inappropriate content, advocacy for certain political, religious, or social movements, or forums for discussing illegal or dangerous activities, by way of non-limiting example. In this case, the parent may perform some or all of the duties of security administrator 150.

Collectively, any object that is or can be designated as belonging to any of the foregoing classes of undesirable objects may be classified as a malicious object. When an unknown object is encountered within secured enterprise 100, it may be initially classified as a “candidate malicious object.” This designation may be to ensure that it is not granted full network privileges until the object is further analyzed. Thus, it is a goal of users 120 and security administrator 150 to configure and operate client devices 110 and enterprise network 170 so as to exclude all malicious objects, and to promptly and accurately classify candidate malicious objects.

In FIG. 1, simply note that the purpose of a predicted user authentication system of the present Specification is to exclude candidate malicious objects from enterprise network 170 until they can be properly classified, or to restrict their access to resources. It is also to ensure that users 120 can access appropriate resources in the context of their activities. A well-designed and properly functioning secured enterprise 100 will grants users 120 access to appropriate resources, while excluding attacker 180 from those resources. Advantageously, the predictive user authentication system of the present Specification performs this function without requiring superfluous authentication activities are tokens from user's 120.

Security administrator 150 may define certain policies, including the degrees of confidence necessary to access certain resources, and other policies such as a timeout for when a user needs to enter a password to receive access to resources. These policies will be informed by the context of the activities. Furthermore, there may be exceptions to and or overrides to policies. For example, a user may be required to enter a password every 4 hours to maintain authentication. However, in a crisis situation, the 4 hour standard password time limit may be waived, to provide the user with immediate access to necessary resources.

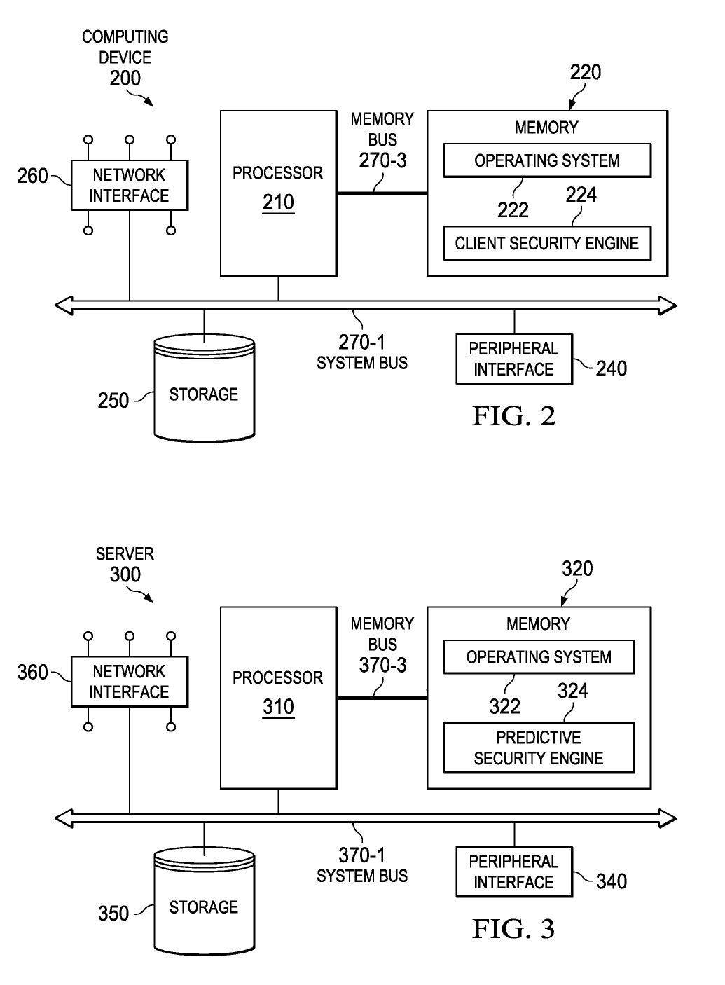

FIG. 2 is a block diagram of computing device 200 according to one or more examples of the present Specification. Computing device 200 may be any suitable computing device. In various embodiments, a “computing device” may be or comprise, by way of non-limiting example, a computer, workstation, server, mainframe, embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data.

In certain embodiments, client devices 110 may all be examples of computing devices 200.

Computing device 200 includes a processor 210 connected to a memory 220, having stored therein executable instructions for providing an operating system 222 and at least software portions of a client security engine 224. Other components of computing device 200 include a storage 250, network interface 260, and peripheral interface 240. This architecture is provided by way of example only, and is intended to be non-exclusive and non-limiting. Furthermore, the various parts disclosed are intended to be logical divisions only, and need not necessarily represent physically separate hardware and/or software components. Certain computing devices provide main memory 220 and storage 250, for example, in a single physical memory device, and in other cases, memory 220 and/or storage 250 are functionally distributed across many physical devices. In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this Specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In an example, processor 210 is communicatively coupled to memory 220 via memory bus 270-3, which may be for example a direct memory access (DMA) bus by way of example, though other memory architectures are possible, including ones in which memory 220 communicates with processor 210 via system bus 270-1 or some other bus. Processor 210 may be communicatively coupled to other devices via a system bus 270-1. As used throughout this Specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 210 may be treated as only one core of a multi-core processor, or may be treated as the entire multi-core processor, as appropriate. In some embodiments, one or more co-processor may also be provided for specialized or support functions.

Processor 210 may be connected to memory 220 in a DMA configuration via DMA bus 270-3. To simplify this disclosure, memory 220 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 220 may comprise a relatively low-latency volatile main memory, while storage 250 may comprise a relatively higher-latency non-volatile memory. However, memory 220 and storage 250 need not be physically separate devices, and in some examples may represent simply a logical separation of function. It should also be noted that although DMA is disclosed by way of non-limiting example, DMA is not the only protocol consistent with this Specification, and that other memory architectures are available.

Storage 250 may be any species of memory 220, or may be a separate device. Storage 250 may include one or more non-transitory computer-readable mediums, including by way of non-limiting example, a hard drive, solid-state drive, external storage, redundant array of independent disks (RAID), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of client security engine 224. Many other configurations are also possible, and are intended to be encompassed within the broad scope of this Specification.

Network interface 260 may be provided to communicatively couple computing device 200 to a wired or wireless network. A “network,” as used throughout this Specification, may include any communicative platform operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Client security engine 224, in one example, is operable to carry out computer-implemented methods as described in this Specification. Client security engine 224 may include one or more non-transitory computer-readable mediums having stored thereon executable instructions operable to instruct a processor to provide a security engine. As used throughout this Specification, an “engine” includes any combination of one or more logic elements, of similar or dissimilar species, operable for and configured to perform one or more methods provided by client security engine 224. Thus, client security engine 224 may comprise one or more logic elements configured to provide methods as disclosed in this Specification. In some cases, client security engine 224 may include a special integrated circuit designed to carry out a method or a part thereof, and may also include software instructions operable to instruct a processor to perform the method. In some cases, client security engine 224 may run as a “daemon” process. A “daemon” may include any program or series of executable instructions, whether implemented in hardware, software, firmware, or any combination thereof, that runs as a background process, a terminate-and-stay-resident program, a service, system extension, control panel, bootup procedure, BIOS subroutine, or any similar program that operates without direct user interaction. In certain embodiments, daemon processes may run with elevated privileges in a “driver space,” or in ring 0, 1, or 2 in a protection ring architecture. It should also be noted that client security engine 224 may also include other hardware and software, including configuration files, registry entries, and interactive or user-mode software by way of non-limiting example.

In one example, client security engine 224 includes executable instructions stored on a non-transitory medium operable to perform a method according to this Specification. At an appropriate time, such as upon booting computing device 200 or upon a command from operating system 222 or a user 120, processor 210 may retrieve a copy of client security engine 224 (or software portions thereof) from storage 250 and load it into memory 220. Processor 210 may then iteratively execute the instructions of client security engine 224 to provide the desired method.

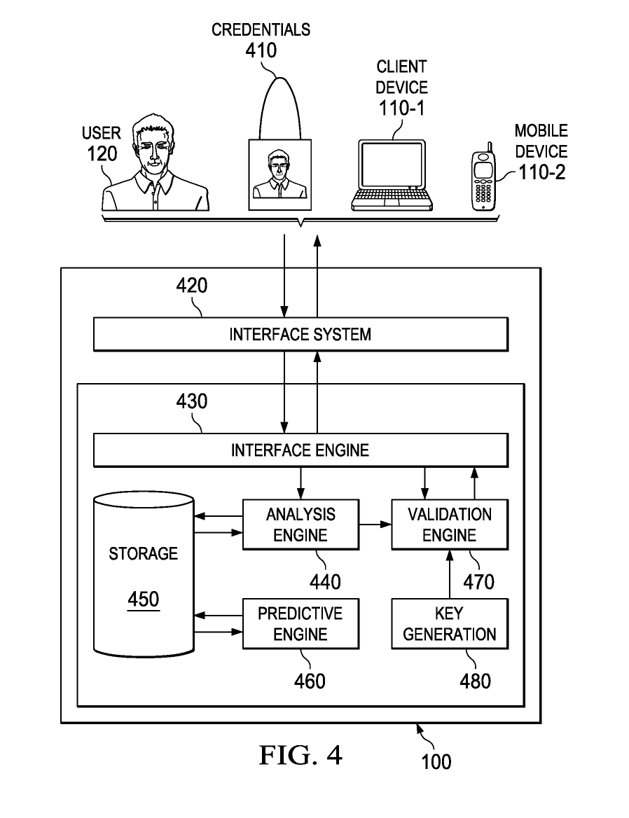

Client security engine 224 may protect or encrypt computing device 110, and may require authentication and optionally a decryption key to provide access to particular resources. Thus, client security engine 224 may request authentication when a user attempts to log in or access a protected action. Alternatively, predictive security engine 324 of FIG. 3 may predict that a user will need authentication and need access to particular resources, and may preemptively provide authentication tokens or decryption keys to client security engine 224, and optionally may also provide instructions for requiring additional authentication from the user.

Peripheral interface 240 may be configured to interface with any auxiliary device that connects to computing device 200 but that is not necessarily a part of the core architecture of computing device 200. A peripheral may be operable to provide extended functionality to computing device 200, and may or may not be wholly dependent on computing device 200. In some cases, a peripheral may be a computing device in its own right. Peripherals may include input and output devices such as displays, terminals, printers, keyboards, mice, modems, network controllers, sensors, transducers, actuators, controllers, data acquisition buses, cameras, microphones, speakers, or external storage by way of non-limiting example.

FIG. 3 is a block diagram of server 140 according to one or more examples of the present Specification. Server 140 may be any suitable computing device, as described in connection with FIG. 2. In general, the definitions and examples of FIG. 2 may be considered as equally applicable to FIG. 3, unless specifically stated otherwise. Server 140 is described herein separately to illustrate that in certain embodiments, logical operations according to this Specification may be divided along a client-server model, wherein computing device 200 provides certain localized tasks, while server 140 provides certain other centralized tasks.

Server 140 includes a processor 310 connected to a memory 320, having stored therein executable instructions for providing an operating system 322 and at least software portions of a predictive security engine 324. Other components of server 140 include a storage 350, network interface 360, and peripheral interface 340. As described in FIG. 2, each logical block may be provided by one or more similar or dissimilar logic elements.

In an example, processor 310 is communicatively coupled to memory 320 via memory bus 370-3, which may be for example a direct memory access (DMA) bus. Processor 310 may be communicatively coupled to other devices via a system bus 370-1.

Processor 310 may be connected to memory 320 in a DMA configuration via DMA bus 370-3, or via any other suitable memory configuration. As discussed in FIG. 2, memory 320 may include one or more logic elements of any suitable type.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of predictive security engine 324.

Network interface 360 may be provided to communicatively couple server 140 to a wired or wireless network, and may include one or more logic elements as described in FIG. 2.

Predictive security engine 324 is an engine as described in FIG. 2 and, in one example, includes one or more logic elements operable to carry out computer-implemented methods as described in this Specification. Software portions of predictive security engine 324 may run as a daemon process.

Predictive security engine 324 may include one or more non-transitory computer-readable mediums having stored thereon executable instructions operable to instruct a processor to provide a security engine. At an appropriate time, such as upon booting server 140 or upon a command from operating system 222 or a user 120 or security administrator 150, processor 310 may retrieve a copy of predictive security engine 324 (or software portions thereof) from storage 350 and load it into memory 320. Processor 310 may then iteratively execute the instructions of predictive security engine 324 to provide the desired method.

Peripheral interface 340 may be configured to interface with any auxiliary device that connects to server 140 but that is not necessarily a part of the core architecture of server 140. A peripheral may be operable to provide extended functionality to server 140, and may or may not be wholly dependent on server 140. Peripherals may include, by way of non-limiting examples, any of the peripherals disclosed in FIG. 2. In a particular example, peripheral interface 240 may provide connectivity to a telemetry subsystem comprising sensors as described herein.

FIG. 4 is a functional block diagram of a predictive security engine 324 according to one or more examples of the present Specification. Predictive security engine 324, as noted above, includes any necessary hardware and/or software to perform its functions.

In this example, user 120 may possess, for example, a client device 110-1 such as a laptop computer, a mobile device 110-2, such as a smart phone, tablet, wearable computer, or implanted computer, or any other appropriate device. User 120 may also possess credentials 410. Credentials 410 may include an RFID or other transmitter by which user 120 can authenticate himself electronically to a device. Furthermore, client device 110-1 and mobile device 110-2 may in some embodiments include encrypted partitions that should only be made available in certain contexts or locations. Leaving aside the example of a hospital momentarily, in one example user 120 may work for an enterprise 100 that handles classified, proprietary, or other sensitive information. It may be convenient to provide client device 11-1 or mobile device 110-2 with encrypted partitions that contain such information, but that cannot be accessed except in specific locations. Thus, when a user 120 enters a particular zone of enterprise 100, a signal from enterprise security controller 140 may be used to authorize decryption of the secured partitions, including a decryption key. This authorization and decryption key may be provided only when user 120 has been sufficiently authenticated to predictive security engine 324.

Predictive security engine 324 may in one example include an interface system 420. Interface system 420 may provide appropriate hardware and software drivers and interfaces to user 120, credentials 410, client device 110-1, and/or mobile device 110-2. This permits predictive security engine 324 to communicatively couple to these endpoints.

Interface engine 430 may provide appropriate software for interface definitions and abstracting communication operations with peripherals or other devices, including telemetry subsystems.

An analysis engine 440 provides the logic to analyze user inputs as described herein. Note the user inputs may be collected automatically, for example from cameras, sensors, and other telemetry devices.

Appropriate inputs may be provided to a validation engine 470, which validates to a degree of confidence that the user or other endpoint is authentic.

A key generator 480 may also be provided to generate appropriate decryption keys.

Predictive engine 460 is used to predict what user 120 may do next or how he may act next. Predictive engine 460 may interoperate with validation engine 470 and analysis engine 440 as appropriate. Predictive engine 460 and analysis engine 440 may store results in a storage database 450, which may include a user authentication profile for each user or other endpoint. As described herein, that profile may be updated continuously over time as new data become available and as a new “normal” is generated.

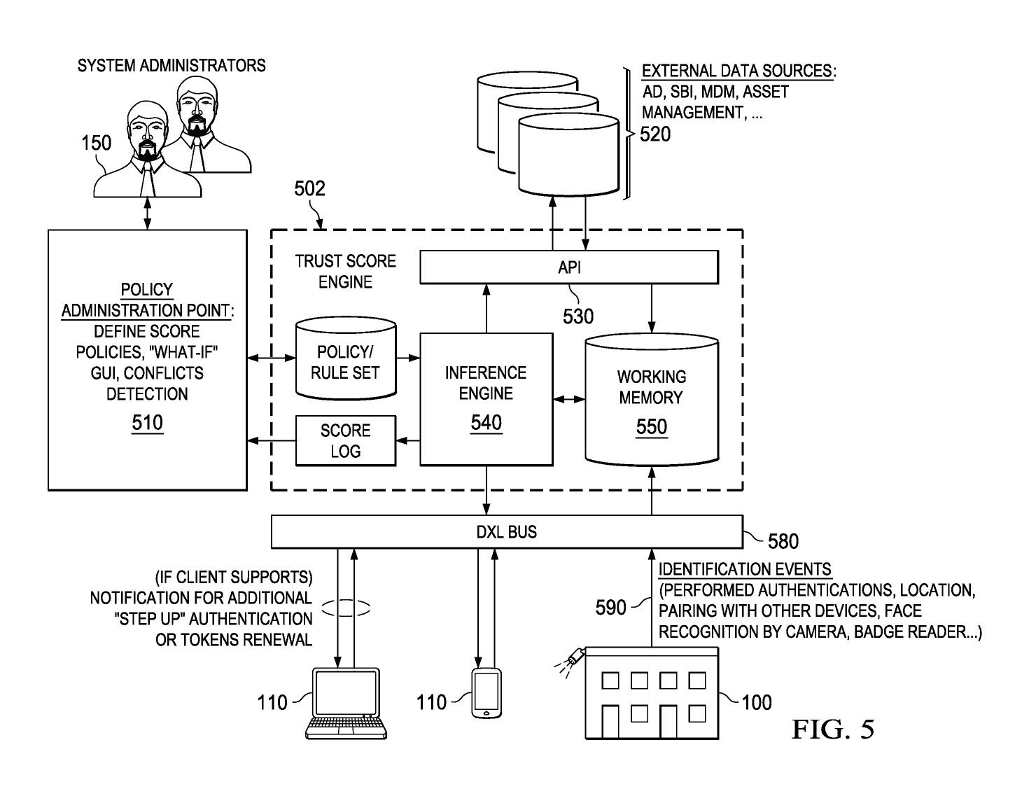

FIG. 5 is a block diagram of selected elements of a predictive user authentication system according to one or more examples of the present Specification. In this example, security administrators 150 interactively administer a policy administration point 510 to define appropriate enterprise policies. These enterprise policies may include required confident scores for authorizing certain activities, “what-if scenarios,” graphical user interfaces, conflicts policies, detection policies, and any other appropriate policies provided herein. These may be refined and modified over time to respond to evolving circumstances and scenarios as they become available.

External data sources 520 may also be available. These may include, by way of nonlimiting example, active directory, SBI, MDM, asset management, and similar. These external data sources are provided via an API 530 to an inference engine 540.

Inference engine 540 has a working memory 550, which may be in one example a species of memory 220. Inference engine 540 also receives a policy or rule set from policy administration point 510. Policy and rule set 560 may be used to shape the behavior of inference engine 540.

Inference engine 540 may also provide score logs 572. This may be used to update policies and heuristics.

In one of example, a data exchange layer (DXL) bus 580 is provided as an interface to client devices 110. This may notify client devices 110 if a user is authenticated, or whether the user needs additional authentication. Thus, client devices 110 can interactively communicate with trust score engine 502 to provide the appropriate authentication experience for end user 120.

Identification events 590 may also be provided by enterprise 100 to trust score engine 502 via DXL bus 580. Identification events may include performed authentications, locations, pairing with other database devices, facial recognition by camera, badge reader, and other identification events discussed herein.

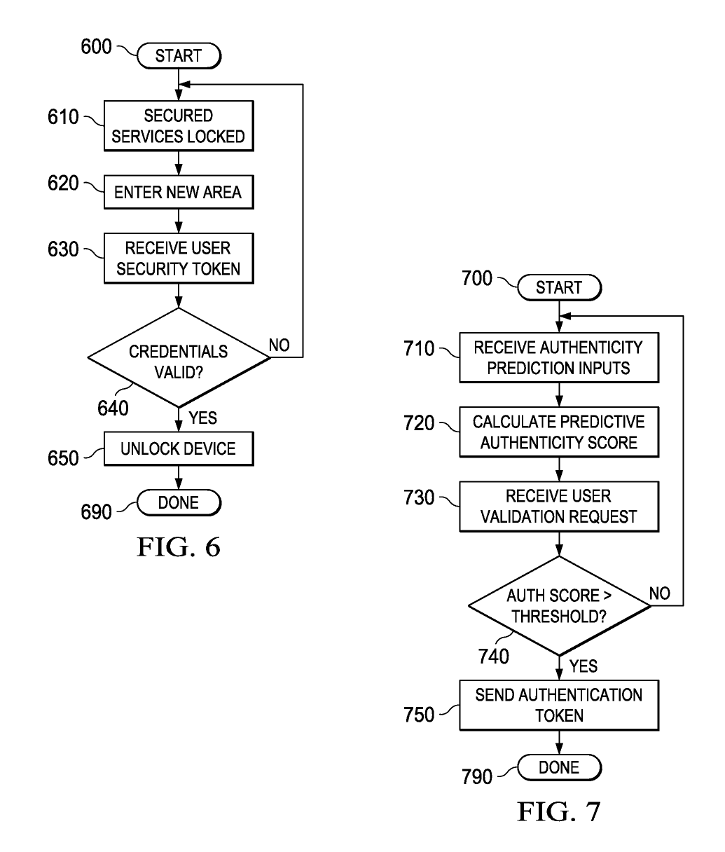

FIG. 6 is a flow chart of a method 600 according to one or more examples of the present Specification.

In block 610, a client device 110 interacts with certain secured services, which initially are locked.

In block 620, a user 120, or the device 110 may enter a new area, such as moving throughout a hospital.

In block 630, client device 110 may receive one or more user security tokens. The security tokens may be a password, security badge, biometric authentication, or any other suitable authentication security token. In some cases, the security token may come not from user 120, but rather from enterprise security controller 140. This may occur in cases where predictive authentication is sufficiently strong for the context to authenticate user 120 without the need of additional inputs.

In block 640, if the credentials are not valid, then the secured services remain locked.

If the credentials are valid, then in block 650, the device unlocks. It should be noted that unlocking is used herein as a generic term to include any provision of access to appropriate resources consistent with this Specification. In some cases, this may include providing access to certain data, automatically displaying certain data, decrypting appropriate partitions, physically unlocking appropriate supply cabinets or drawers, or any other suitable activity for providing access to resources.

In block 690, the method is done.

FIG. 7 is a flow diagram of a method 700 according to one or more examples of the present Specification. In block 710, predictive security engine 324, for example of enterprise security controller 140, receives authenticity prediction inputs. This may include any of the inputs listed in block 590 of FIG. 5, or any other appropriate inputs discussed throughout this Specification.

In block 720, predictive security engine 324 calculates a predictive authenticity score based on the inputs.

In block 730, predictive security engine 324 may receive an explicit validation request, for example from a client device 110. In other cases, the validation request takes the form of predictive security engine 324 predicting, based on identification events, that a user 120 may need access to a certain resource, and proactively providing an internal validation request. This block may also include determining that a predictive authentication score is not high enough, in context, to authorize access to all necessary resources, and thus receiving an authentication request from a client device 110 to provide additional authentication as described herein, or providing to client device 110 instructions to request additional authentication.

In block 740, predictive security engine 324 produces an overall authentication score based on all of the relevant factors. If the score is not greater than a threshold, then authorization is not provided. In this case, additional action may be taken, such as requesting additional verification, or reporting an incident to an enterprise security administrator 150.

In block 750, if the authentication score was greater than the threshold, then predictive security engine 324 sends the authentication token to client device 110. Client device 110 is now prepared to act on the authentication token and provide access to appropriate resources.

In block 790, the method is done.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the Specification, to limit this disclosure in any way that is not otherwise reflected in the appended claims.

### EXAMPLE IMPLEMENTATIONS

There is disclosed in an example, an apparatus comprising: a sensor subsystem for providing a telemetry input; and one or more logic elements comprising a predictive security engine operable for: receiving the telemetry input from the sensor subsystem; calculating a predictive authentication score for a user based at least in part on the telemetry input; and authenticating the user based at least in part on the predictive authentication score.

There is further disclosed an example, wherein the predictive security engine is further operable for inferring a context based at least in part on the telemetry input, and providing context-sensitive data or access based on the inferring.

There is further disclosed an example, wherein the sensor subsystem comprises a camera.

There is further disclosed an example, wherein the sensor subsystem further comprises a computer vision engine.

There is further disclosed an example, wherein the telemetry input comprises a proximity trigger.

There is further disclosed an example, wherein the proximity trigger comprises a radio frequency identification (RFID) reader signal.

There is further disclosed an example, wherein the predictive security engine is further operable for selecting an additional authentication mechanism based at least in part on the predictive authentication score.

There is further disclosed an example, wherein the predictive security engine is further operable for providing scaled authentication based at least in part on the predictive authentication score, and further based at least in part on a resource that the user is to access.

There is further disclosed an example, wherein the telemetry input comprises a biometric authentication mechanism.

There is further disclosed an example, wherein the biometric authentication mechanism comprises a fingerprint scanner.

There is further disclosed an example, wherein the biometric authentication mechanism comprises a voice print scanner.

There is further disclosed an example, wherein the predictive security engine is further operable for: detecting an emergency event; and adjusting the predictive authentication score at least in part responsive to the emergency event.

There is further disclosed an example, wherein the predictive security engine is further operable for providing data or access responsive at least in part to the emergency event.

There is further disclosed in an example, one or more computer-readable storage mediums having stored thereon executable instructions to provide a predictive security engine operable for: receiving a telemetry input from a sensor subsystem; calculating a predictive authentication score for a user based at least in part on the telemetry input; and authenticating the user based at least in part on the predictive authentication score.

There is further disclosed an example, wherein the predictive security engine is further operable for inferring a context based at least in part on the telemetry input, and providing context-sensitive data or access based on the inferring.

There is further disclosed an example, wherein the telemetry input comprises a camera image.

There is further disclosed an example, wherein executable instructions are further operable for providing a computer vision system.

There is further disclosed an example, wherein the telemetry input comprises a proximity trigger input.

There is further disclosed an example, wherein the predictive security engine is further operable for selecting an additional authentication mechanism based at least in part on the predictive authentication score.

There is further disclosed an example, wherein the predictive security engine is further operable for providing scaled authentication based at least in part on the predictive authentication score, and further based at least in part on a resource that the user is to access.

There is further disclosed an example, wherein the telemetry input comprises a biometric input.

There is further disclosed an example, wherein the predictive security engine is further operable for: detecting an emergency event; and adjusting the predictive authentication score at least in part responsive to the emergency event.

There is further disclosed an example, wherein the predictive security engine is further operable for providing data or access responsive at least in part to the emergency event.

There is further disclosed in an example, a computer-implemented method, comprising: receiving a telemetry input from a sensor subsystem; calculating a predictive authentication score for a user based at least in part on the telemetry input; and authenticating the user based at least in part on the predictive authentication score.

There is further disclosed an example, further comprising inferring a context based at least in part on the telemetry input, and providing context-sensitive data or access based on the inferring.

There is further disclosed in an example, a method comprising performing the instructions disclosed in any of the examples.

There is further disclosed in an example, an apparatus comprising means for performing the method of any of the examples.

There is further disclosed an example, wherein the apparatus comprises a processor and memory.

There is further disclosed in an example, an apparatus further comprising a computer-readable medium having stored thereon software instructions for performing the method of any of the examples.

What is claimed is:

1. An apparatus comprising:
a sensor subsystem for providing a telemetry input; and
one or more logic elements comprising a predictive security engine operable for:
receiving the telemetry input from the sensor subsystem;
calculating a predictive authentication score for a user based at least in part on the telemetry input; and
authenticating the user based at least in part on the predictive authentication score.

2. The apparatus of claim 1, wherein the predictive security engine is further operable for inferring a context based at least in part on the telemetry input, and providing context-sensitive data or access based on the inferring.

3. The apparatus of claim 1, wherein the sensor subsystem comprises a camera.

4. The apparatus of claim 3, wherein the sensor subsystem further comprises a computer vision engine.

5. The apparatus of claim 1, wherein the telemetry input comprises a proximity trigger.

6. The apparatus of claim 5, wherein the proximity trigger comprises a radio frequency identification (RFID) reader signal.

7. The apparatus of claim 1, wherein the predictive security engine is further operable for selecting an additional authentication mechanism based at least in part on the predictive authentication score.

8. The apparatus of claim 1, wherein the predictive security engine is further operable for providing scaled authentication based at least in part on the predictive authentication score, and further based at least in part on a resource that the user is to access.

9. The apparatus of claim 1, wherein the telemetry input comprises a biometric authentication mechanism.

10. The apparatus of claim 9, wherein the biometric authentication mechanism comprises a fingerprint scanner.

11. The apparatus of claim 9, wherein the biometric authentication mechanism comprises a voice print scanner.

12. The apparatus of claim 1, wherein the predictive security engine is further operable for:
detecting an emergency event; and
adjusting the predictive authentication score at least in part responsive to the emergency event.

13. The apparatus of claim 12, wherein the predictive security engine is further operable for providing data or access responsive at least in part to the emergency event.

14. One or more computer-readable storage mediums having stored thereon executable instructions to provide a predictive security engine operable for:
receiving a telemetry input from a sensor subsystem;
calculating a predictive authentication score for a user based at least in part on the telemetry input; and
authenticating the user based at least in part on the predictive authentication score.

15. The one or more computer-readable mediums of claim 14, wherein the predictive security engine is further operable for inferring a context based at least in part on the telemetry input, and providing context-sensitive data or access based on the inferring.

16. The one or more computer-readable mediums of claim 14, wherein the telemetry input comprises a camera image.

17. The one or more computer-readable mediums of claim 16, wherein executable instructions are further operable for providing a computer vision system.

18. The one or more computer-readable mediums of claim 14, wherein the telemetry input comprises a proximity trigger input.

19. The one or more computer-readable mediums of claim 14, wherein the predictive security engine is further operable for selecting an additional authentication mechanism based at least in part on the predictive authentication score.

20. The one or more computer-readable mediums of claim 14, wherein the predictive security engine is further operable for providing scaled authentication based at least in part on the predictive authentication score, and further based at least in part on a resource that the user is to access.

21. The one or more computer-readable mediums of claim 14, wherein the telemetry input comprises a biometric input.

22. The one or more computer-readable mediums of claim 14, wherein the predictive security engine is further operable for:
detecting an emergency event; and
adjusting the predictive authentication score at least in part responsive to the emergency event.

23. The one or more computer-readable mediums of claim 22, wherein the predictive security engine is further operable for providing data or access responsive at least in part to the emergency event.

24. A computer-implemented method, comprising:
receiving a telemetry input from a sensor subsystem;
calculating a predictive authentication score for a user based at least in part on the telemetry input; and
authenticating the user based at least in part on the predictive authentication score.

25. The computer-implemented method of claim 24, further comprising inferring a context based at least in part on the telemetry input, and providing context-sensitive data or access based on the inferring.
